(19) United States
(12) Patent Application Publication
(10) Pub. No.: US 2013/0299458 A1
(43) Pub. Date: Nov. 14, 2013

(54) ELECTRICAL DISCHARGE MACHINING SYSTEM AND METHOD FOR ELECTIRCAL DISCHARGE MACHINING USING THE SAME

(71) Applicants: Chong Nam Chu, Seoul (KR); Ki Young Song, Anyang-si (KR); Do Kwan Chung, Seoul (KR)

(72) Inventors: Chong Nam Chu, Seoul (KR); Ki Young Song, Anyang-si (KR); Do Kwan Chung, Seoul (KR)

(21) Appl. No.: 13/473,596

(22) Filed: May 17, 2012

(30) Foreign Application Priority Data
May 10, 2012 (KR) 10-2012-0049757

(51) Int. Cl. B23H 1/00

(52) U.S. Cl. 219/69.11

(57) ABSTRACT

An electrical discharge machining (EDM) system and a method for electrical discharge machining using the above-mentioned machining system, the EDM system includes a bed, and an EDM module disposed on the bed. The EDM module includes an electrode, a providing part, an electrode guide and a retrieving part. The electrode machines a die. The providing part provides the electrode to be used for machining the die. The electrode guide is disposed adjacent to the die and guides a transfer of the electrode. The retrieving part retrieves the electrode used for machining the die.

### CROSS-REFERENCE TO RELATED APPLICATION

This application claims priority to Korean Patent Application No. 2012-00000, filed on Apr. 0, 2012, and all the benefits accruing therefrom under 35 U.S.C. §119, the contents of which in its entirety is herein incorporated by reference.

### BACKGROUND OF THE INVENTION

1. Field of the Invention

Exemplary embodiments of the present invention relate to an electrical discharge machining system and a method for electrical discharge machining using the above-mentioned machining system. More particularly, exemplary embodiments of the present invention relate to an electrical discharge machining system having improved machinability and a method for electrical discharge machining using the above-mentioned machining system.

2. Description of the Related Art

Generally, an electrical discharge machining (EDM) is a conventional machining process using an electrical discharge. In the EDM, a machine tool and a die sink in an insulating fluid and a high voltage is applied to a gap between the machine tool and the die to be discharged, and thus the die is machined. The EDM is conventionally applied to a precision machining to manufacture a precision structure having various kinds of shapes.

FIGS. 1A and 1B illustrate poor machinability due to a wear of an electrode in the conventional EDM. Referring to FIGS. 1A and 1B, in the EDM, a die 10 is machined using a spark due to the discharge between an electrode 15 and the die 10, and thus the wear of the electrode is inevitable. Thus, when the electrode 15 is transferred along a direction indicated as an arrow in FIG. 1A to form the die 10 as an originally designed shape 11, the wear 17 of the electrode 15 forms a machined die 12 having a shape different from the originally designed shape 11 by a machining error d1. To decrease the machining error d1 of the machined die 12, a path of the electrode 15 should be corrected along a direction (Z direction) substantially perpendicular to the above-mentioned arrow direction, and thus the correction of the path of the electrode 15 should be additionally researched considering the wear of the electrode.

### BRIEF SUMMARY OF THE INVENTION

Example embodiments of the present invention provide an electrical discharge machining (EDM) system capable of improving machinability.

Example embodiments of the present invention also provide a method for EDM using the above-mentioned machining system.

In an example embodiment of an EDM system according to the present invention, the EDM system includes a bed and an EDM module disposed on the bed. The EDM module includes an electrode, a providing part, an electrode guide and a retrieving part. The electrode machines a die. The providing part provides the electrode to be used for machining the die. The electrode guide is disposed adjacent to the die and guides a transfer of the electrode. The retrieving part retrieves the electrode used for machining the die.

In the example embodiment, the electrode may have a tape shape or a foil shape.

In the example embodiment, the electrode may include a copper or a brass.

In the example embodiment, the providing part may provide the electrode with rotating the electrode wound on the providing part, and the retrieving part may retrieve the electrode with rotating the electrode to be wound on the retrieving part.

In the example embodiment, the electrode guide may include a head portion making contact with the electrode, and an extending portion spaced apart from the electrode and extending from the head portion. The electrode may be transferred on the head portion.

In the example embodiment, the electrode may make contact with the head portion machines the die.

In the example embodiment, an end of the head portion may be curved.

In the example embodiment, the EDM module may be integrally transferred along a machining path.

In the example embodiment, the electrode guide may include a main guide and a sub guide. The main guide may move up and down. The sub guide may be combined with the main guide at both sides of the main guide such that the main guide may move up and down with respect to the sub guide.

In the example embodiment, the main guide may include a guide body portion, and a guide portion extending from the guide body portion to be a prism shape. The electrode may be guided along an end of the guide portion and an external surface of the sub guide.

In an example embodiment of a method for EDM according to the present invention, an electrode is provided to be used for machining a die from a providing part of an EDM module disposed on a bed. The die is machined using the electrode provided by the providing part. The electrode is guided by an electrode guide disposed adjacent to the die. The electrode used for machining the die is retrieved to a retrieving part of the EDM module.

In the example embodiment, the providing part may provide the electrode with rotating the electrode wound on the providing part, and the retrieving part may retrieve the electrode with rotating the electrode to be wound on the retrieving part.

In the example embodiment, the electrode may have a tape shape or a foil shape.

In the example embodiment, in machining the die, the electrode may be transferred on a head portion of the electrode guide with making contact with the head portion, and the electrode may make contact with the head portion machines the die.

In the example embodiment, the machining the die may include milling the die or turning the die.

In the example embodiment, the electrode guide may include a main guide and a sub guide. The main guide may move up and down. The sub guide may be combined with the main guide at both sides of the main guide such that the main guide may move up and down with respect to the sub guide. In machining the die, the electrode may be guided along an end of the main guide and an external surface of the sub guide.

In the example embodiment, in machining the die, an inclination angle of a ‘V’ groove of the die machined by the electrode may be changed according to a position of the main guide with respect to the sub guide.

According to the above-mentioned example embodiments, an electrode used for the EDM has a tape shape or a foil shape, and the electrode is continuously provided and retrieved to prevent a machining error from occurring due to the wear of the electrode.

In addition, the electrode has a constant cross-sectional area and is continuously provided, to minimize the machining error due to the wear of the electrode.

In addition, the electrode only makes contact with a head portion of an electrode guide in machining, so that a friction in providing the electrode may be minimized to decrease a damage of the electrode and the electrode may be transferred much faster.

In addition, an end of the head portion of the electrode guide is curved to transfer the electrode much smoother.

In addition, the electrode guide includes a main guide moving up and down, and the electrode guide includes a guide portion having a prism shape, so that a ‘V’ groove having various inclination angles may be formed.

### BRIEF DESCRIPTION OF THE DRAWINGS

The above and other features and advantages of the present invention will become more apparent by describing in detailed exemplary embodiments thereof with reference to the accompanying drawings, in which:

FIGS. 1A and 1B are schematic diagrams explaining poor machinability due to a wear of an electrode in a conventional electrical discharge machining (EDM);

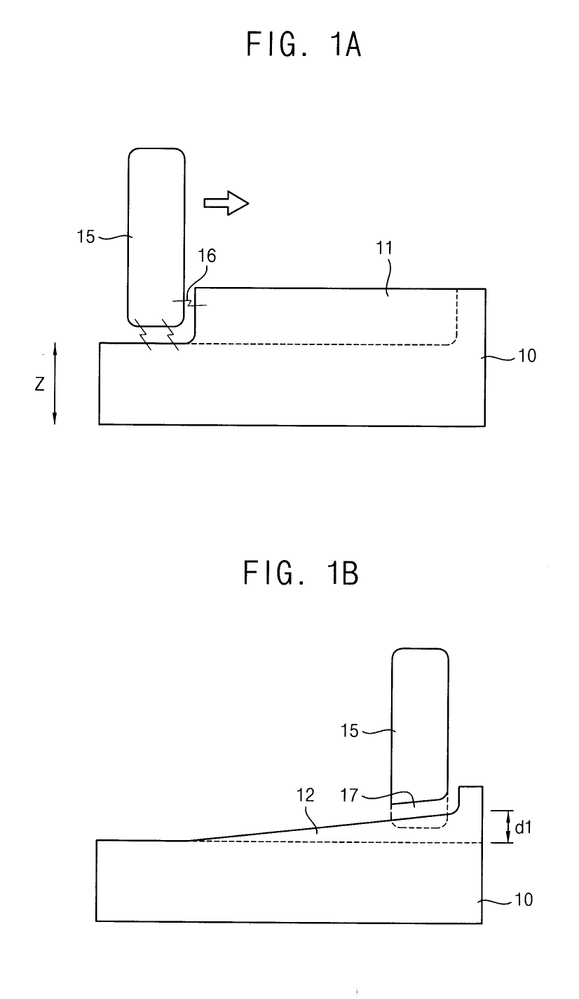

FIG. 2A is a schematic diagram illustrating an EDM system according to an example embodiment of the invention;

FIG. 2B is a front view illustrating a portion ‘A’ in FIG. 2A;

FIGS. 3A, 3B and 3C are schematic diagrams illustrating a turning EDM using the EDM system of FIG. 2A;

FIGS. 4A, 4B and 4C are schematic diagrams illustrating a milling EDM using the EDM system of FIG. 2A;

FIG. 5 is a perspective view illustrating an electrode guide according to another example embodiment of the present invention; and

FIGS. 6A and 6B are schematic diagrams illustrating a ‘V’ groove EDM using the electrode guide of FIG. 5.

### DETAILED DESCRIPTION OF THE INVENTION

Hereinafter, exemplary embodiments of the present invention will be described in further detail with reference to the accompanying drawings.

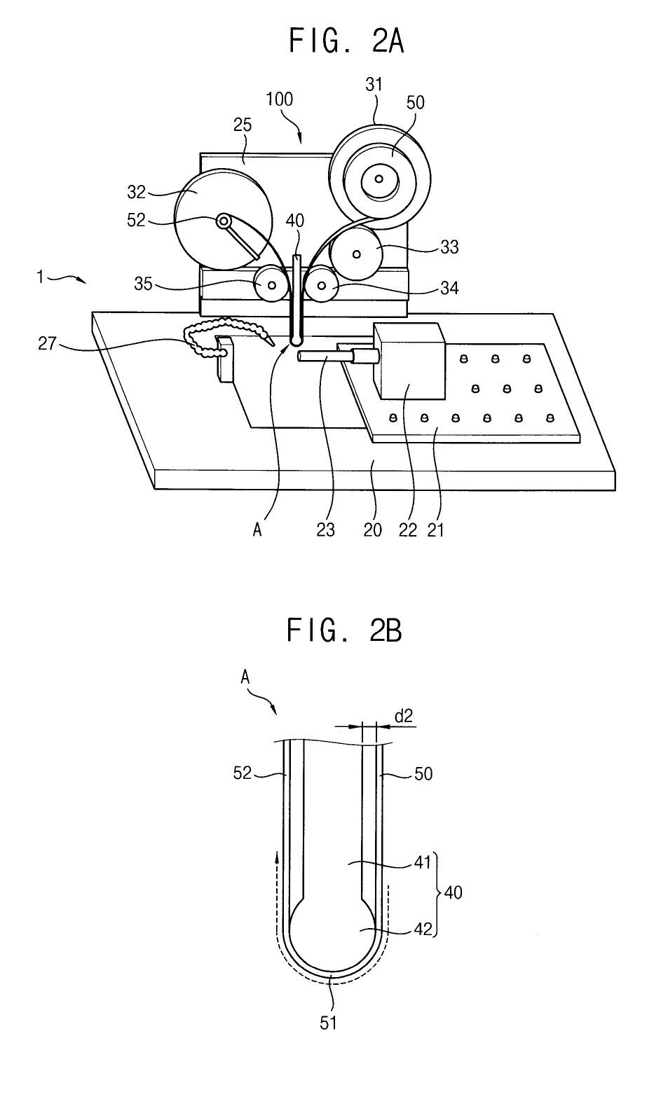

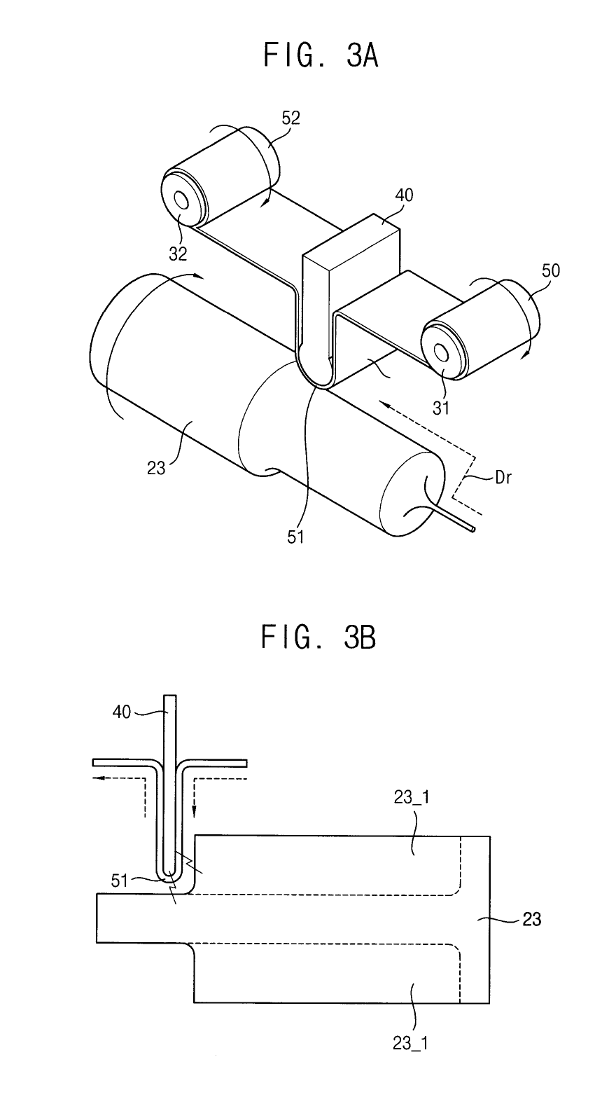

FIG. 2A is a schematic diagram illustrating an electrical discharge machining (EDM) system according to an example embodiment of the invention. FIG. 2B is a front view illustrating a portion ‘A’ in FIG. 2A.

Referring to FIGS. 2A and 2B, the EDM system 1 according to the present example embodiment includes a bed 20, a plate 21, a fluid providing part 27 and an EDM module 100.

The bed 20 is functioned as a fixing frame of the EDM system 1, and the plate 21, the fluid providing part 27 and the EDM module 100 are disposed on the bed 20. The plate 21 is transferred or fixed on the bed 20, and a die fixing part 22 is transferred or fixed on the plate 21. The die fixing part 22 fixes the die 23. In FIG. 2A, the die 23 is fixed by the die fixing part 22 for a turning machining, but the die 23 may be fixed for a milling machining or other kinds of machining

Although not shown in figure, the EDM system 1 may further include a driver. The driver may control a transfer of the EDM module 100, a transfer of the electrode of the EDM module 100 and so on. The EDM module 100 is integrally transferred to machine the die 23.

The fluid providing part 27 provides a fluid to both of the electrode and the die 23. In an EDM, the electrode and the die both sink in the fluid and are discharged to be machined, and thus the fluid providing part 27 provides the fluid enough to improve machinability of the die 23.

The EDM module 100 is disposed on the bed 20, and includes a providing part 31, an electrode 50, 51 and 52, an electrode guide 40 and a retrieving part 32. The EDM module 100 may further include first and second rollers 33 and 34 disposed between the providing part 31 and the electrode guide 40, and a third roller 35 disposed between the electrode guide 40 and the retrieving part 32.

The providing part 31, the electrode guide 40, the retrieving part 32 and the first, second and third rollers 33, 34 and 35 may be fixed to a base plate 25 which is disposed substantially perpendicular to the bed 20. The elements fixed to the base plate 25 may be integrally transferred on the bed 20. For example, the EDM module 100 may be integrally transferred on the bed 20 in machining the die 23. Here, the die 23 may be transferred with respect to the EDM module 100 due to the transfer of the plate 21, and thus the die 23 may be variously machined.

The providing part 31 is fixed on the base plate 25 with a circular plate shape, and the electrode 50 which will be used for machining is wound on the providing part 31.

In the present example embodiment, the electrode 50, 51 and 52 includes a tape shape or a foil shape, and thus the electrode 50, 51 and 52 may be wound on the providing part 31 with a cylindrical shape. For example, the electrode 50, 51 and 52 may have a relatively thin thickness and a relatively large width, and the width of the electrode 50, 51 and 52 may be variously changed according to a size of the die 23 and a designed shape of the machined die 23.

The electrode 50, 51 and 52 has a width much larger than a thickness thereof, compared to a wire-shape electrode conventionally used in the EDM. Thus, a width of the die 23 may be changed according to the width of the electrode 50, 51 and 52, so that the die 23 may be machined variously according to the width of the electrode 50, 51 and 52. In addition, an amount of machined die according to the present example embodiment may be larger than that in the conventional wire EDM, and thus the machinability may be enhanced.

The first and second rollers 33 and 34 are disposed between the providing part 31 and the electrode guide 40, and are fixed on the base plate 25. The first and second rollers 33 and 34 maintain a tension of the electrode 50 provided from the providing part 31 to the electrode guide 40 and prevent the electrode 50 from sagging in providing the electrode 50, and thus the electrode 50 may be effectively provided.

The electrode guide 40 is disposed adjacent to the die 23 and receives the electrode 50 from the providing part 31 and guides the electrode 50, so that the electrode 51 may easily and effectively machine the die 23.

For example, the electrode guide 40 includes a head portion 42 and an extending portion 41. The electrode 51 provided from the providing part 31 makes contact with the head portion 42, and the extending portion 41 extends from the head portion 42 and is fixed to the base plate 25. The head portion 42 is curved as illustrated in FIG. 2B and, for example, a cross-sectional shape of the head portion 42 may be a circle. Here, a diameter of the head portion 42 is larger than a width of the extending portion 41. Thus, the electrode 51 is transferred with making contact with a curved surface of the head portion 42, but is spaced apart from the extending portion 41 by a constant distance d2.

Accordingly, the electrode 51 is transferred with making contact with the curved surface of the head portion 42, and the electrode 51 making contact with the head portion 42 machines the die 23. Here, the electrode 51 is transferred along an arrow direction in FIG. 2B. Thus, even though the electrode 51 is worn in machining the die 23, the worn electrode 52 is retrieved to the retrieving part 32 and the electrode 50 is newly and continuously provided to the die 23, so that the die 23 may be effectively machined with the new electrode 50 which is not worn. Accordingly, the machinability of the die 23 may be improved, and the path of the electrode guide 40 or the path of the die 23 is unnecessary to be corrected considering the wear of the electrode 51.

The retrieving part 32 retrieves the electrode 52 which is worn after the EDM of the die 23. The retrieving part 32 is fixed to the base plate 25 and has a circular plate shape like the providing part 31. The retrieving part 32 retrieves the worn electrode 52 with rotating the electrode to be wound on the retrieving part 32.

The third roller 35 is disposed between the electrode guide 40 and the retrieving part 32, and is fixed on the base plate 25. The third roller 35 maintains a tension when the electrode 52 used for the EDM of the die 23 is retrieved to the retrieving part 32, and thus the electrode 52 may be prevented from sagging and may be smoothly and efficiently retrieved to the retrieving part 32.

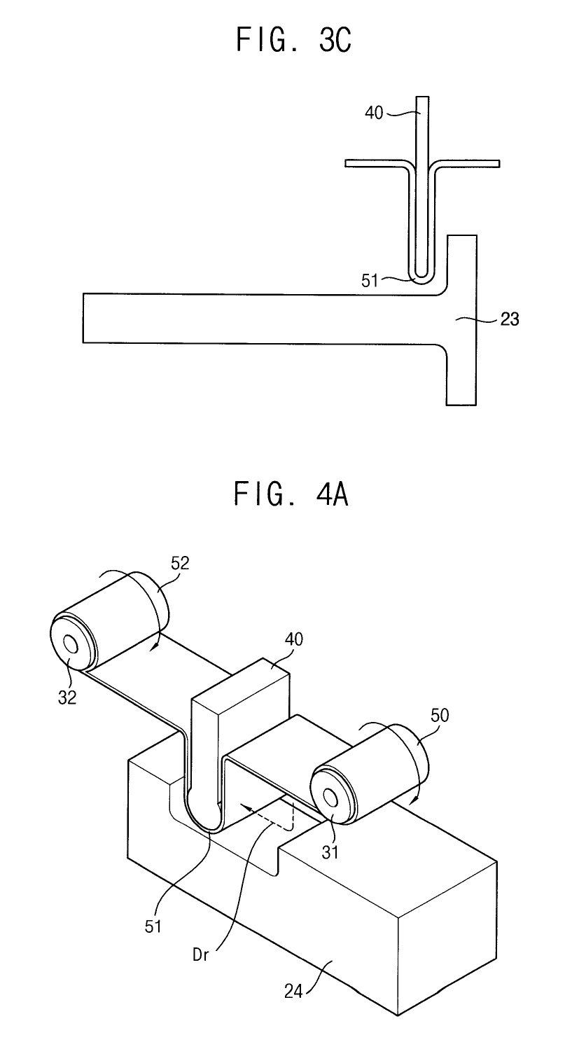

FIGS. 3A, 3B and 3C are schematic diagrams illustrating a turning EDM using the EDM system of FIG. 2A.

Referring to FIG. 3A, in the turning EDM using the EDM system according to the present example embodiment, the die 23 is fixed to the die fixing part 22 and the die 23 rotates along an arrow direction with respect to a central axis as illustrated in FIG. 3A. In addition, the EDM module 100 is integrally transferred along a tool path Dr. For example, the EDM module 100 is integrally transferred, and thus the providing part 31, the electrode guide 40 and the retrieving part 32 are also transferred along the tool path Dr. Thus, the electrode 51 guided by the electrode guide 40 is transferred along the tool path Dr and the turning EDM of the die 23 rotating along the arrow direction is performed.

Here, referring to FIGS. 3B and 3C, in the turning EDM, the die 23 rotates, the new electrode 50 properly substitutes for the electrode 51, and the worn electrode 52 is properly retrieved by the retrieving part 32, so that an initially designed shape of the die 23_1 may be manufactured without an additional correction for the tool path Dr considering the wear of the electrode in a conventional turning EDM. Accordingly, the electrode 51 is transferred by the electrode guide 40 for the turning EDM of the die 23, and thus the initially designed shape of the die 23_1 may be easily completed.

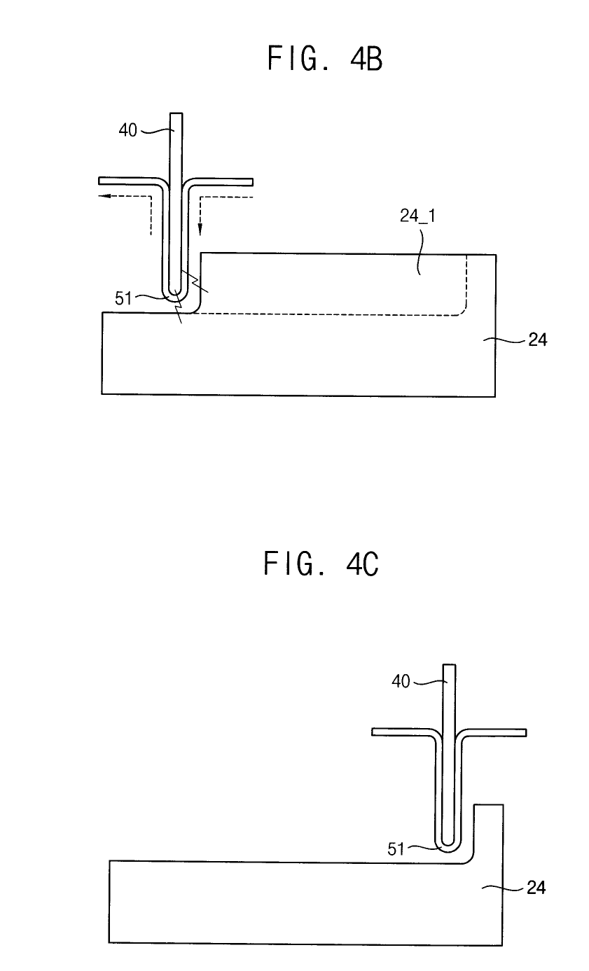

FIGS. 4A, 4B and 4C are schematic diagrams illustrating a milling EDM using the EDM system of FIG. 2A.

Referring to FIG. 4A, in the milling EDM using the EDM system according to the present example embodiment, a die 24 is fixed to the die fixing part 22 and the EDM module 100 is integrally transferred along the tool path Dr. For example, the EDM module 100 is integrally transferred, and thus the providing part 31, the electrode guide 40 and the retrieving part 32 are also transferred along the tool path Dr. Thus, the electrode 51 guided by the electrode guide 40 is transferred along the tool path Dr and the milling EDM of the die 24 is performed.

Alternatively, the die 24 fixed to the die fixing part 22 is transferred along a direction opposite to the tool path Dr and the EDM module stands without moving, and then the milling EDM of the die 24 may be performed.

Here, referring to FIGS. 4B and 4C, in the milling EDM, the die 24 stands without moving, the new electrode 50 properly substitutes for the electrode 51, and the worn electrode 52 is properly retrieved by the retrieving part 32, so that an initially designed shape of the die 24_1 may be manufactured without an additional correction for the tool path Dr considering the wear of the electrode in a conventional milling EDM. Accordingly, the electrode 51 is transferred by the electrode guide 40 for the milling EDM of the die 24, and thus the initially designed shape of the die 24_1 may be easily completed.

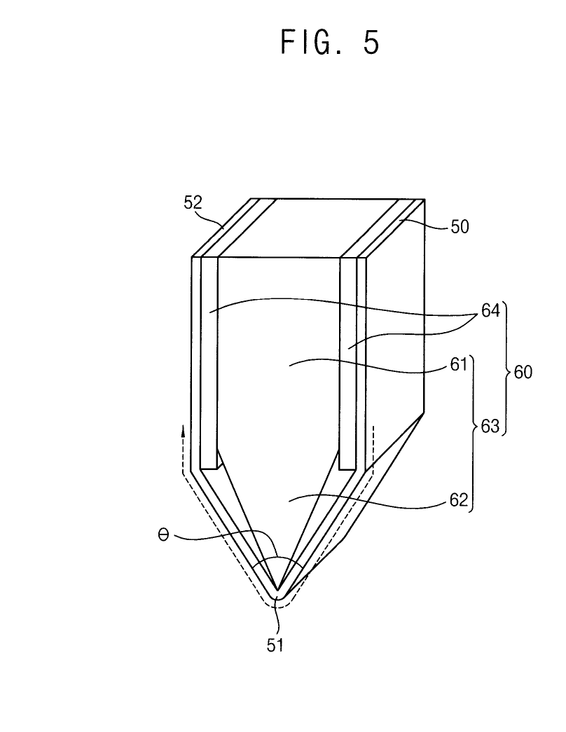

FIG. 5 is a perspective view illustrating an electrode guide according to another example embodiment of the present invention.

The electrode guide 60 according to the present example embodiment is substantially same as the electrode guide 40 according to the previous example embodiment except for a shape thereof, a structure thereof and a supporting structure thereof for the electrode, and the electrode guide 60 according to the present example embodiment may substitute for the electrode guide 40 according to the previous example embodiment in the EDM system 1 as illustrated in FIG. 2A. Thus, the same reference numerals will be used to refer to the same or like parts as those described in the previous example embodiment and any further repetitive explanation concerning the above elements will be omitted.

Referring to FIG. 5, the electrode guide 60 according to the present example embodiment includes a main guide 63 and a sub guide 64. The main guide 63 is combined with the sub guide 64, and moves up and down with respect to the sub guide 64. For example, the sub guide 64 stands at a fixed position and the main guide 63 moves up and down with respect to the sub guide 64 sliding between side surfaces of a pair of sub guides 64.

The main guide 63 includes a guide body portion 61 and a guide portion 62. The guide body portion 61 has a rectangular column shape having a constant cross-sectional area, and both side surfaces of the guide body portion 61 make contact with the sub guide 64. The guide portion 62 extends from the guide body portion 61 to a lower portion of the guide body portion 61 and has a prism shape. For example, an end of the guide portion 62 has a sharp-pointed shape as illustrated in FIG. 5.

The electrode 50 provided by the providing part 31 is guided by the side surface of the sub guide 64, and then the die 65 is machined by the electrode 51 which is guided by the end of the guide portion 62. Then, the electrode 52 used for the EDM of the die 65 is guided by the side surface of the sub guide 64 and is retrieved by the retrieving part 32.

Here, the main guide 63 moves upwardly or downwardly with respect to the sub guide 64, and thus an angle θ of the electrode 51 guided by the end of the guide portion 62 may change.

For example, when the main guide 63 is positioned relatively upwardly with respect to the sub guide 64, a portion of the guide portion 62 which is protruded between the pair of sub guides 64 decreases so that the angle θ of the electrode 51 guided by the end of the guide portion 62 may increase. Thus, an inclined angle of a ‘V’ groove formed at the die 65 which is machined by the electrode 51 may increase and the ‘V’ groove may have a relatively larger inclined angle therein.

However, when the main guide 63 is positioned relatively downwardly with respect to the sub guide 64, the portion of the guide portion 62 which is protruded between the pair of sub guides 64 increases so that the angle θ of the electrode 51 guided by the end of the guide portion 62 may decrease. Thus, the inclined angle of the ‘V’ groove formed at the die 65 which is machined by the electrode 51 may decrease and the ‘V’ groove may have the relatively smaller inclined angle therein.

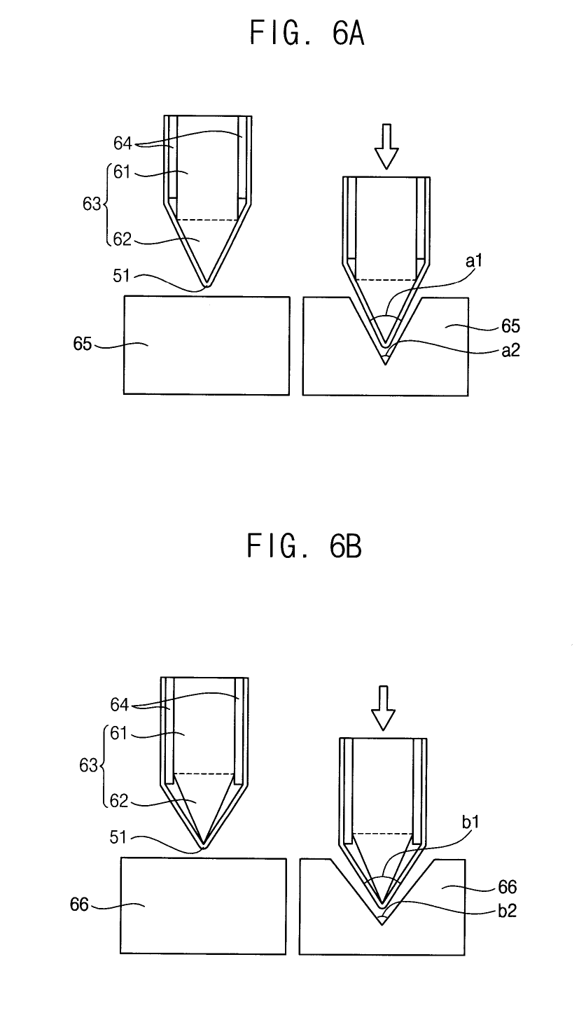

Accordingly, the position of the main guide 63 with respect to the sub guide 64 changes, and thus the inclined angle of the ‘V’ groove may change variously. Hereinafter, examples of the ‘V’ groove are explained referring to FIGS. 6A and 6B.

FIGS. 6A and 6B are schematic diagrams illustrating a ‘V’ groove EDM using the electrode guide of FIG. 5.

Referring to FIG. 6A, the main guide 63 moves relatively downwardly with respect to the sub guide 64 and the portion of the guide portion 62 which is protruded between the pair of the sub guides 64 relatively increases. Then, the main guide 63 and the sub guide 64 integrally move downward and perform the EDM of the die 65. Here, the electrode 51 guided by the end of the guide portion 62 has a relatively decreased angle a1, and thus the ‘V’ groove of the die 65 formed by the electrode 51 has a relatively decreased angle a2 and has a relatively narrower groove shape.

However, referring to FIG. 6B, the main guide 63 moves relatively upwardly with respect to the sub guide 64 and the portion of the guide portion 62 which is protruded between the pair of the sub guides 64 relatively decreases. Then, the main guide 63 and the sub guide 64 integrally move downward and perform the EDM of a die 66. Here, the electrode 51 guided by the end of the guide portion 62 has a relatively increased angle b1, and thus the ‘V’ groove of the die 66 formed by the electrode 51 has a relatively increased angle b2 and has a relatively wider groove shape.

Accordingly, the position of the main guide 63 with respect to the sub guide 64 changes, and thus the inclined angle of the ‘V’ groove formed at the die may change variously. In addition, the electrode 51 is continuously provided with newly one, and thus the wear of the electrode 51 has no effect on the shape of the ‘V’ groove formed at the die.

According to the above-mentioned example embodiments, an electrode used for the EDM has a tape shape or a foil shape, and the electrode is continuously provided and retrieved to prevent a machining error from occurring due to the wear of the electrode.

In addition, the electrode has a constant cross-sectional area and is continuously provided, to minimize the machining error due to the wear of the electrode.

In addition, the electrode only makes contact with a head portion of an electrode guide in machining, so that a friction in providing the electrode may be minimized to decrease a damage of the electrode and the electrode may be transferred much faster.

In addition, an end of the head portion of the electrode guide is curved to transfer the electrode much smoother.

In addition, the electrode guide includes a main guide moving up and down, and the electrode guide includes a guide portion having a prism shape, so that a ‘V’ groove having various inclination angles may be formed.

The foregoing is illustrative of the present invention and is not to be construed as limiting thereof. Although a few example embodiments of the present invention have been described, those skilled in the art will readily appreciate that many modifications are possible in the example embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific example embodiments disclosed, and that modifies to the disclosed example embodiments, as well as other example embodiments, are intended to be included within the scope of the appended claims. The present invention is defined by the following claims, with equivalents of the claims to be included therein.

What is claimed is:

1. An electrical discharge machining (EDM) system comprising a bed, and an EDM module disposed on the bed, the EDM module comprising:
an electrode machining a die;
a providing part providing the electrode to be used for machining the die;
an electrode guide disposed adjacent to the die and guiding a transfer of the electrode; and
a retrieving part retrieving the electrode used for machining the die.

2. The EDM system of claim 1, wherein the electrode has a tape shape or a foil shape.

3. The EDM system of claim 2, wherein the electrode comprises a copper or a brass.

4. The EDM system of claim 2, wherein the providing part provides the electrode with rotating the electrode wound on the providing part, and the retrieving part retrieves the electrode with rotating the electrode to be wound on the retrieving part.

5. The EDM system of claim 1, wherein the electrode guide comprises a head portion making contact with the electrode, and an extending portion spaced apart from the electrode and extending from the head portion,
wherein the electrode is transferred on the head portion.

6. The EDM system of claim 5, wherein the electrode making contact with the head portion machines the die.

7. The EDM system of claim 6, wherein an end of the head portion is curved.

8. The EDM system of claim 1, wherein the EDM module is integrally transferred along a machining path.

9. The EDM system of claim 1, wherein the electrode guide comprises:
a main guide moving up and down; and
a sub guide combined with the main guide at both sides of the main guide such that the main guide moves up and down with respect to the sub guide.

10. The EDM system of claim 9, wherein the main guide comprises a guide body portion, and a guide portion extending from the guide body portion to be a prism shape,
wherein the electrode is guided along an end of the guide portion and an external surface of the sub guide.

11. A method for EDM comprising:
providing an electrode to be used for machining a die from a providing part of an EDM module disposed on a bed;
machining the die using the electrode provided by the providing part, the electrode being guided by an electrode guide disposed adjacent to the die; and
retrieving the electrode used for machining the die to a retrieving part of the EDM module.

12. The method of claim 11, wherein the providing part provides the electrode with rotating the electrode wound on the providing part, and the retrieving part retrieves the electrode with rotating the electrode to be wound on the retrieving part.

13. The method of claim 12, wherein the electrode has a tape shape or a foil shape.

14. The method of claim 11, wherein in machining the die, the electrode is transferred on a head portion of the electrode guide with making contact with the head portion, and the electrode making contact with the head portion machines the die.

15. The method of claim 14, wherein the machining the die comprises milling the die or turning the die.

16. The method of claim 11, wherein the electrode guide comprises:
a main guide moving up and down; and
a sub guide combined with the main guide at both sides of the main guide such that the main guide moves up and down with respect to the sub guide,
wherein in machining the die, the electrode is guided along an end of the main guide and an external surface of the sub guide.

17. The method of claim 16, wherein in machining the die, an inclination angle of a ‘V’ groove of the die machined by the electrode is changed according to a position of the main guide with respect to the sub guide.
